(19) United States
(12) Patent Application Publication
(10) Pub. No.: US 2026/0046783 A1
(43) Pub. Date: Feb. 12, 2026

(54) METHOD AND APPARATUS FOR SENDING UPLINK TRANSMISSION POWER CONFIGURATION, METHOD AND APPARATUS FOR RECEIVING UPLINK TRANSMISSION POWER CONFIGURATION, AND SYSTEM

(71) Applicant: Beijing Xiaomi Mobile Software Co., Ltd., Beijing (CN)

(72) Inventors: Juan ZHANG, Beijing (CN); Xueyuan GAO, Beijing (CN)

(73) Assignee: Beijing Xiaomi Mobile Software Co., Ltd., Beijing (CN)

(21) Appl. No.: 19/103,000

(22) PCT Filed: Aug. 11, 2022
(86) PCT No.: PCT/CN2022/111821

§ 371 Date: Feb. 11, 2025

(51) Int. Cl. H04W 52/14; H04W 52/34

(52) U.S. Cl. CPC H04W 52/146; H04W 52/34

(57) ABSTRACT

The present disclosure is applied to a wireless communication system. Provided are a method and apparatus for sending an uplink transmission power configuration, a method and apparatus for receiving an uplink transmission power configuration, and a system. The method for receiving an uplink transmission power configuration comprises: receiving N pieces of uplink transmission power configuration information sent by a network device, wherein the uplink transmission power configuration information is used for configuring the uplink transmission power of one of N antenna panels of a user equipment; and controlling the uplink transmission power of the N antenna panels according to the N pieces of uplink transmission power configuration information.

### CROSS-REFERENCE

The present application is a U.S. National Stage of International Application No. PCT/CN2022/111821, filed on Aug. 11, 2022, the entire content of which is incorporated herein by reference for all purposes.

### TECHNICAL FIELD

The present disclosure relates to a field of wireless communication technology, and specifically, to a method and an apparatus for sending uplink transmission power configuration, a method and an apparatus for receiving uplink transmission power configuration and a system.

### BACKGROUND

In a New Radio (NR) system, a multi-point coordination approach is adopted to improve coverage at cell edges and provide more balanced quality of service within the service region.

With the increasing use of millimeter wave bands, where millimeter waves refer to electromagnetic waves with wavelengths ranging from 1 to 10 millimeters, their extremely short wavelengths result in more significant blocking effects caused by various obstacles. In this case, to ensure the robustness of link connections, it is also possible to utilize coordination between multiple transmission-reception points (TRPs) or panels to transmit from multiple angles with multiple beams, thereby decreasing the adverse effects caused by the blocking. In some embodiments, for uplink and downlink data, a user device may only transmit or receive a single beam on the same antenna panel. In some other embodiments, augmentation is performed for the downlink direction, allowing the user device to receive beams from different TRPs in a plurality of directions on a plurality of antenna panels simultaneously. In some embodiments, it would be expected that in the uplink direction, the user device transmits different beams on the plurality of antenna panels simultaneously.

Since path losses of different TRPs may vary, it is necessary to consider how to perform the uplink power control for different TRPs.

### SUMMARY

The present disclosure provides a method and an apparatus for sending uplink transmission power configuration, a method and an apparatus for receiving uplink transmission power configuration and a system.

In a first aspect, a method for receiving uplink transmission power configuration is provided, the method is performed by a user device, and includes:
receiving N pieces of uplink transmission power configuration information sent by a network device, where the uplink transmission power configuration information is used to configure an uplink transmission power of one antenna panel among N antenna panels of the user device; and
controlling, according to the N pieces of uplink transmission power configuration information, the uplink transmission powers of the N antenna panels.

In a second aspect, a method for receiving uplink transmission power configuration is provided, the method is performed by a user device and includes:
receiving uplink transmission power configuration information sent by a network device, where the uplink transmission power configuration information is used to configure an uplink transmission power of the user device; and
controlling, according to the uplink transmission power configuration information, uplink transmission powers of different antenna panels in the user device.

In a third aspect, a method for sending uplink transmission power configuration is provided, the method is performed by a network device and includes:
sending N pieces of uplink transmission power configuration information to a user device, where the uplink transmission power configuration information is used to configure an uplink transmission power of one antenna panel among N antenna panels of the user device.

In a fourth aspect, a method for sending uplink transmission power configuration is provided, the method is performed by a network device and includes:
sending uplink transmission power configuration information to a user device, where the uplink transmission power configuration information is used to configure an uplink transmission power of the user device.

In a fifth aspect, a communication device is provided and includes a processor and a memory,
where the memory is configured to store a computer program; and
the processor is configured to execute the computer program to implement a design according to any one of above first aspect or second aspect.

In a sixth aspect, a communication device is provided and includes a processor and a memory,
where the memory is configured to store a computer program; and
the processor is configured to execute the computer program to implement the design according to any one of above third aspect or fourth aspect.

In a seventh aspect, a communication system is provided and includes a user device to perform any one of the above and a network device to perform any one of the above.

### BRIEF DESCRIPTION OF THE DRAWINGS

The accompanying drawings described herein are used to provide a further understanding of embodiments of the present disclosure and constitute a part of the present disclosure. The embodiments of the present disclosure and their descriptions are used to explain the embodiments of the present disclosure and do not constitute improper limitations to the embodiments of the present disclosure. In the accompanying drawings:

The accompanying drawings, which are incorporated in and constitute a part of this specification, illustrate embodiments consistent with the present disclosure and, together with the description, serve to explain the principles of the present disclosure.

FIG. 1 is a schematic diagram of a wireless communication system architecture provided in embodiments of the present disclosure;

FIG. 2 is a schematic diagram of an interaction for sending uplink transmission power configuration provided in embodiments of the present disclosure;

FIG. 3 is a schematic diagram of an interaction for sending uplink transmission power configuration provided in embodiments of the present disclosure;

FIG. 4 is a schematic diagram of an interaction for sending uplink transmission power configuration provided in embodiments of the present disclosure;

FIG. 5 is a structural schematic diagram for receiving uplink transmission power configuration provided in embodiments of the present disclosure;

FIG. 6 is a structural schematic diagram for sending uplink transmission power configuration provided in embodiments of the present disclosure.

### DETAILED DESCRIPTION

The embodiments of the present disclosure are further described with reference to the accompanying drawings and the detailed description.

The embodiments are described in detail here, examples of which are illustrated in the accompanying drawings. When the following description involves the accompanying drawings, unless otherwise indicated, the same numbers in different drawings represent the same or similar elements. The embodiments described in the following embodiments do not represent all embodiments consistent with the embodiments of the present disclosure. On the contrary, they are merely examples of apparatus and methods consistent with some aspects of the present disclosure as detailed in the appended claims.

The terms used in the present disclosure are for the purpose of describing particular examples only, and are not intended to limit the present disclosure. Terms determined by “a,” “the” and “said” in their singular forms in the present disclosure and the appended claims are also intended to include plurality or multiple, unless clearly indicated otherwise in the context. It should also be understood that the term “and/or” as used herein is and includes any and all possible combinations of one or more of the associated listed items.

It should be understood that, although terms “first,” “second,” “third” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” and “whether” as used herein may be interpreted as “when” or “upon” or “in response to determining”.

The embodiments of the present disclosure are described in detail below. Examples of the embodiments are illustrated in the accompanying drawings where the same or similar numbers throughout indicate the same or similar elements. The embodiments described below by reference to the accompanying drawings are illustrative and are intended to interpret the present disclosure and are not to be construed as a limitation of the present disclosure.

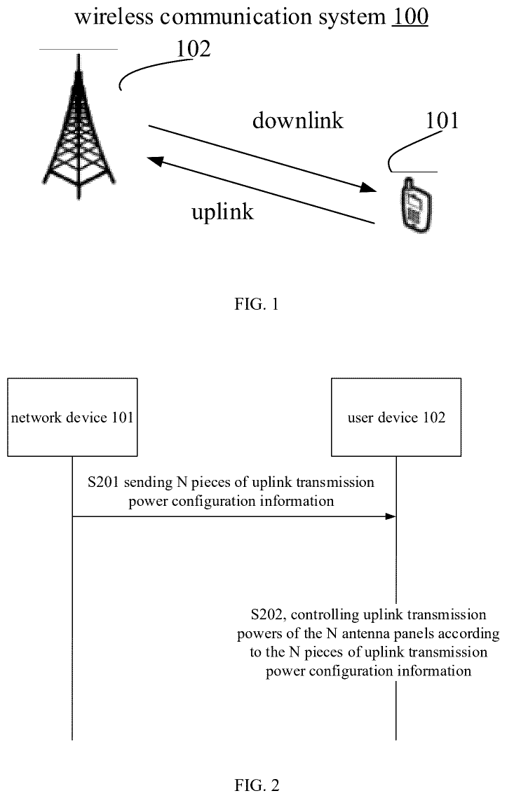

As shown in FIG. 1, a method for sending and receiving uplink transmission power configuration provided by the embodiments of the present disclosure may be applied to a wireless communication system 100, which may include, but is not limited to, a network device 101 and a user device 102. The user device 102 is configured to support carrier aggregation, and may be connected to a plurality of carrier units of the network device 101, the plurality of carrier units including one primary carrier unit and one or more secondary carrier units.

It should be understood that the wireless communication system 100 may be applicable to both low frequency and high frequency scenarios. Application scenarios of the wireless communication system 100 include, but are not limited to, a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-generation (5G) system, a new radio (NR) communication system or a future evolution public land mobile network (PLMN) system, etc.

The above-mentioned user device 102 may be a user device (terminal), an access user device, a user device unit, a user device station, a mobile station (MS), a remote station, a remote user device, a mobile user device (mobile terminal), a wireless communication apparatus, a user device agent, or other user devices. The user device 102 may have wireless transceiver function, and is capable of communicating (e.g., wirelessly communicating) with one or more network devices of one or more communication systems and receiving network services provided by the network devices. The network devices here include, but are not limited to, the illustrated network device 103.

The user device 102 may be a cellular phone, a cordless phone, a session initiation protocol (SIP) phone, a wireless local loop (WLL) station, a personal digital assistant (PDA) device, a handheld device with a wireless communication capability, a computing device or other processing device connected to a wireless modem, an in-vehicle device, a wearable device, a user device in a future 5G network or a user device in a future evolution PLMN network.

The network device 101 may be an access network device (or referred to as an access network site). The access network device refers to a device providing a network access function, such as a radio access network (RAN) base station. The network device 103 may specifically include a base station (BS), or include the base station device and a radio resource management device configured to control the base station device, and the like. The network device 101 may further include a relay station (a relay device), an access point, and a base station in the future 5G network, a base station in the future evolution PLMN network, or an NR base station. The network device 101 may be a wearable device or an in-vehicle device. The network device 101 may also be a communication chip with a communication module.

For example, the network device 101 includes, but is not limited to, a next-generation base station (gnodeB, gNB) in 5G, an evolved node B (eNB) in the LTE system, a radio network controller (RNC), a node B (NB) in a wideband code division multiple access (WCDMA) system, a radio controller under the CRAN system, a base station controller (BSC), a base transceiver station (BTS) in a global system for mobile communications (GSM) or code division multiple access (CDMA) system, a home base station (for example, a home evolved nodeB, or a home node B (HNB)), a baseband unit (BBU), a transmitting and receiving point (TRP), a transmitting point (TP) or a mobile switching center.

Since path losses of different TRPs may vary, if uplink power control is performed with the user device as the granularity, it may result in transmission failures on some beams due to insufficient transmission power, while excessive transmission power on other beams may cause adjacent channel interference, energy waste, and other issues.

The embodiments of the present disclosure provide a method for sending and receiving uplink transmission power configuration. FIG. 2 illustrates a flowchart of a method for sending and receiving uplink transmission power configuration according to an embodiment. As shown in FIG. 2, the method comprises steps S201 to S202, specifically:
In S201, a network device sends N pieces of uplink transmission power configuration information to a user device.

Any one of the N pieces of uplink transmission power configuration information is used to an uplink transmission power of one antenna panel among N antenna panels of the user device. In one example, N is a total number of antenna panels in the user device.

In some embodiments, a corresponding relationship between the N pieces of uplink transmission power configuration information and the antenna panels is implemented through Manner 1 or Manner 2.
Manner 1: the uplink transmission power configuration information includes an identification of the antenna panel.

The user device determines which antenna panel each uplink transmission power configuration information is used to control according to the identification of the antenna panel included in each uplink transmission power configuration information.
Manner 2: the uplink transmission power configuration information does not include an identification of the antenna panel, and locations of the N pieces of uplink transmission power configuration information in an RRC signaling correspond to a preset order of the antenna panels.

The user device determines which antenna panel each uplink transmission power configuration information is used to control according to the location of each uplink transmission power configuration information in the RRC signaling and the preset order of the antenna panels.
In S202, the user device controls uplink transmission powers of the N antenna panels according to the N pieces of uplink transmission power configuration information.

Corresponding to Manner 1, the uplink transmission power of the antenna panel corresponding to the uplink transmission power configuration information is controlled according to the identification of the antenna panel in the uplink transmission power configuration information.

Corresponding to Manner 2, the uplink transmission power of the antenna panel corresponding to the uplink transmission power configuration information is controlled according to the locations of the N pieces of uplink transmission power configuration information in the RRC signaling and the preset order of the antenna panels.

In some embodiments, the user device determines a maximum uplink transmission power of each antenna panel among the N antenna panels according to a protocol agreement.

In the embodiments of the present disclosure, the network device configures the uplink transmission power configuration information for each antenna panel of the user device separately, and the user device controls the uplink transmission power for each antenna panel of the user device separately, and that is, the configuration and power control are performed with the antenna panel as the granularity. Based on the different transmission capabilities of different antenna panels, the uplink transmission power corresponding to the transmission capability is allocated to the antenna panels with different transmission capabilities, such that the uplink transmission power of each antenna panel matches the transmission capability, which fully utilizes the transmission capability of each antenna panel, thereby avoiding the issues of transmission failure caused by insufficient transmission power and adjacent channel interference or energy waste caused by excessive transmission power.

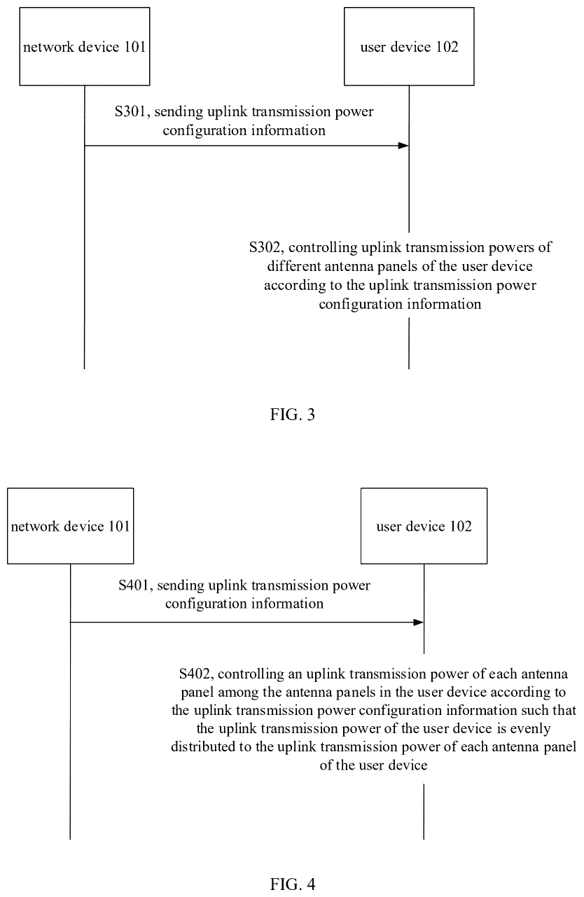

The embodiments of the present disclosure provide a method for sending and receiving uplink transmission power configuration. FIG. 3 illustrates a flowchart of a method for sending and receiving uplink transmission power configuration according to an embodiment. As shown in FIG. 3, the method includes steps S301 to S302, specifically:
in step S301: a network device sends uplink transmission power configuration information to a user device.

The uplink transmission power configuration information is used to configure the uplink transmission power of the user device.
In step S302: the user device controls uplink transmission powers of different antenna panels of the user device according to the uplink transmission power configuration information.

In some embodiments, a sum of uplink transmission powers of M antenna panels in the user device is less than or equal to a preset threshold, where M is a positive integer and less than or equal to N, and N is a total number of the antenna panels in the user device.

In some embodiments, the uplink transmission powers of M antenna panels are controlled according to a priority of signals emitted by the different antenna panels, where M is a positive integer which is greater than 1 and less than or equal to N, and N is a number of antenna panels included in the user device, and a sum of the uplink transmission powers of the M antenna panels in the user device is greater than a preset threshold.

In the embodiments of the present disclosure, the network device configures uplink transmission power configuration information for the user device, and the user device controls the uplink transmission power for each antenna panel of the user device separately, that is, the power configuration is performed with the user device as the granularity, and the power control is performed with the antenna panel as the granularity. Based on the different transmission capabilities of different antenna panels, the uplink transmission power corresponding to the transmission capability is allocated to the antenna panels with different transmission capabilities, such that the uplink transmission power of each antenna panel matches the transmission capability, which fully utilizes the transmission capabilities of each antenna panel, thereby avoiding the issues of transmission failure caused by insufficient transmission power and adjacent channel interference or energy waste caused by excessive transmission power.

The embodiments of the present disclosure provide a method for sending and receiving uplink transmission power configuration. FIG. 4 illustrates a flowchart of a method for sending and receiving uplink transmission power configuration according to an embodiment. As shown in FIG. 4, the method includes steps S401 to S402, specifically:
In step S401: a network device sends uplink transmission power configuration information to a user device.

The uplink transmission power configuration information is used to configure an uplink transmission power of the user device.
In step S402: the user device controls an uplink transmission power of each antenna panel among the antenna panels in the user device according to the uplink transmission power configuration information such that the uplink transmission power of the user device is evenly distributed to the uplink transmission power of each antenna panel of the user device.

In the embodiment of the present disclosure, the network device configures uplink transmission power configuration information for the user device, and the user device controls uplink transmission power for each antenna panel of the user device separately, and that is, the power configuration is performed with the user device as the granularity, and the power control is performed with the antenna panel as the granularity by evenly distributing the uplink transmission power of the user device to each antenna panel, which may, to a certain extent, avoid issues of transmission failure caused by insufficient transmission power and adjacent channel interference or energy waste caused by excessive transmission power.

Based on the same concept as the above method embodiments, embodiments of the present disclosure also provide a communication apparatus that may have a function of the user device 102 in the above method embodiments and be configured to perform steps provided by the user device 102 in the above embodiments. The function may be implemented in a form of hardware, in a form of software or in a form of hardware executing corresponding software. The hardware or software includes one or more modules corresponding to the function described above.

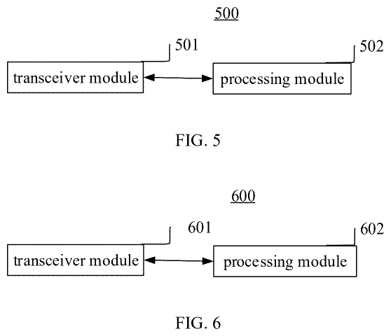

In an embodiment, the communication apparatus 500 shown in FIG. 5 may serve as the user device 102 involved in the above method embodiments and perform the steps performed by the user device 102 in the above method embodiments.

The communication apparatus 500 includes a transceiver module 501 and a processing module 502.

The transceiver module 501 is configured to receive N pieces of uplink transmission power configuration information sent by a network device, where the uplink transmission power configuration information is used to an uplink transmission power of one antenna panel among N antenna panels of the user device;
The processing module 502 is configured to control uplink transmission powers of the N antenna panels according to the N pieces of uplink transmission power configuration information.

In some embodiments, the uplink transmission power configuration information includes an identification of the antenna panel;
the processing module 502 is further configured to control the uplink transmission power of the antenna panel corresponding to the uplink transmission power configuration information according to the identification of the antenna panel.

In some embodiments, a maximum uplink transmission power of each antenna panel in the N antenna panels of the user device is determined according to a protocol agreement.

In an embodiment, the communication apparatus 500 shown in FIG. 5 may serve as the user device 102 involved in the above method embodiments and perform the steps performed by the user device 102 in the above method embodiments.

The transceiver module 501 is configured to receive uplink transmission power configuration information sent by a network device, and the uplink transmission power configuration information is used to configure an uplink transmission power of the user device;

The processing module 502 is configured to control uplink transmission powers of different antenna panels in the user device according to the uplink transmission power configuration information.

In an embodiment, a sum of uplink transmission powers of M antenna panels in the user device is less than or equal to a preset threshold, where M is a positive integer and less than or equal to N, and N is a total number of the antenna panels in the user device.

In an embodiment, the processing module 502 is further configured to control uplink transmission powers of M antenna panels according to a priority of signals transmitted by different antenna panels, where M is a positive integer and less than or equal to N, and Nis a number of antenna panels included in the user device, and a sum of the uplink transmission powers of the M antenna panels in the user device is greater than a preset threshold.

In an embodiment, the uplink transmission power of the user device is evenly distributed to an uplink transmission power of each antenna panel of the user device.

Based on the same concept as the above method embodiments, the embodiments of the present disclosure also provide a communication apparatus that may have a function of the network device 101 in the above method embodiments and be configured to perform steps provided by the network device 101 in the above embodiments. The function may be implemented in a form of hardware, in a form of software or in a form of hardware executing corresponding software. The hardware or software includes one or more modules corresponding to the function described above.

In an embodiment, the communication apparatus 600 shown in FIG. 6 may serve as the network device 101 involved in the above method embodiments and perform the steps performed by the network device 101 in the above method embodiments.

The communication apparatus 600 includes a transceiver module 601 and a processing module 602.

The transceiver module 601 is configured to send N pieces of uplink transmission power configuration information to the user device, where the uplink transmission power configuration information is used to configure an uplink transmission power of one antenna panel among N antenna panels of the user device.

In an embodiment, the uplink transmission power configuration information includes an identification of the antenna panel.

In an embodiment, the processing module 602 is configured to determine a maximum uplink transmission power of each of the N antenna panels according to a protocol agreement.

In an embodiment, the communication apparatus 600 shown in FIG. 6 may serve as the network device 101 involved in the above method embodiments and perform the steps performed by the network device 101 in the above method embodiments.

The transceiver module 601 is configured to send uplink transmission power configuration information to a user device, where the uplink transmission power configuration information is used to configure an uplink transmission power of the user device.

In an embodiment, a sum of uplink transmission powers of M antenna panels in the user device is less than or equal to a preset threshold, where M is a positive integer and less than or equal to N, and N is a total number of the antenna panels in the user device.

In an embodiment, the uplink transmission power of the user device is evenly distributed to an uplink transmission power of each antenna panel of the user device.

In a first aspect, a method for receiving uplink transmission power configuration is provided, the method is performed by a user device, and includes:
receiving N pieces of uplink transmission power configuration information sent by a network device, where the uplink transmission power configuration information is used to configure an uplink transmission power of one antenna panel among N antenna panels of the user device; and
controlling, according to the N pieces of uplink transmission power configuration information, the uplink transmission powers of the N antenna panels.

In the present method, the network device configures the uplink transmission power configuration information for each antenna panel of the user device separately, and the user device controls the uplink transmission power for each antenna panel of the user device separately, and that is, the configuration and power control are performed with the antenna panel as the granularity. Based on the different transmission capabilities of different antenna panels, the uplink transmission power corresponding to the transmission capability is allocated to the antenna panels with different transmission capabilities, such that the uplink transmission power of each antenna panel matches the transmission capability, which fully utilizes the transmission capability of each antenna panel, thereby avoiding the issues of transmission failure caused by insufficient transmission power and adjacent channel interference or energy waste caused by excessive transmission power.

In some embodiments, the uplink transmission power configuration information includes an identification of the antenna panel;
where the controlling the uplink transmission powers of the N antenna panels according to the N pieces of uplink transmission power configuration information, respectively includes: controlling, according to the identification of the antenna panel, the uplink transmission power of the antenna panel corresponding to the uplink transmission power configuration information.

In some embodiments, the method further includes:
determining, according to a protocol agreement, a maximum uplink transmission power of each antenna panel among the N antenna panels.

In a second aspect, a method for receiving uplink transmission power configuration is provided, the method is performed by a user device and includes:
receiving uplink transmission power configuration information sent by a network device, where the uplink transmission power configuration information is used to configure an uplink transmission power of the user device; and
controlling, according to the uplink transmission power configuration information, uplink transmission powers of different antenna panels in the user device.

In the present method, the network device configures uplink transmission power configuration information for the user device, and the user device controls the uplink transmission power for each antenna panel of the user device separately, that is, the power configuration is performed with the user device as the granularity, and the power control is performed with the antenna panel as the granularity. Based on the different transmission capabilities of different antenna panels, the uplink transmission power corresponding to the transmission capability is allocated to the antenna panels with different transmission capabilities, such that the uplink transmission power of each antenna panel matches the transmission capability, which fully utilizes the transmission capabilities of each antenna panel, thereby avoiding the issues of transmission failure caused by insufficient transmission power and adjacent channel interference or energy waste caused by excessive transmission power.

In some embodiments, a sum of uplink transmission powers of M antenna panels in the user device is less than or equal to a preset threshold, where M is a positive integer which is greater than 1 and less than or equal to N, and N is a total number of the antenna panels in the user device.

In some embodiments, the controlling the uplink transmission powers of the different antenna panels in the user device includes:
controlling, according to a priority of signals emitted by the different antenna panels, uplink transmission powers of M antenna panels, where M is a positive integer and less than or equal to N, and N is a number of antenna panels included in the user device, and a sum of the uplink transmission powers of the M antenna panels in the user device is greater than a preset threshold.

In some embodiments, the uplink transmission power of the user device is evenly distributed to an uplink transmission power of each antenna panel of the user device.

In a third aspect, a method for sending uplink transmission power configuration is provided, the method is performed by a network device and includes:
sending N pieces of uplink transmission power configuration information to a user device, where the uplink transmission power configuration information is used to configure an uplink transmission power of one antenna panel among N antenna panels of the user device.

In some embodiments, the uplink transmission power configuration information includes an identification of the antenna panel.

In some embodiments, the method further includes:
determining, according to a protocol agreement, a maximum uplink transmission power of each antenna panel among the N antenna panels.

In a fourth aspect, a method for sending uplink transmission power configuration is provided, the method is performed by a network device and includes:
sending uplink transmission power configuration information to a user device, where the uplink transmission power configuration information is used to configure an uplink transmission power of the user device.

In some embodiments, a sum of uplink transmission powers of M antenna panels in the user device is less than or equal to a preset threshold, where M is a positive integer and less than or equal to N, and N is a total number of the antenna panels in the user device.

In some embodiments, the uplink transmission power of the user device is evenly distributed to an uplink transmission power of each antenna panel of the user device.

In a fifth aspect, a user device is provided and includes:
a transceiver module, configured to receive N pieces of uplink transmission power configuration information sent by a network device, where the uplink transmission power configuration information is used to configure an uplink transmission power of one antenna panel among N antenna panels of the user device;
a processing module, configured to control uplink transmission powers of the N antenna panels according to the N pieces of uplink transmission power configuration information.

In a sixth aspect, a user device is provided and includes:
a transceiver module, configured to receive uplink transmission power configuration information sent by a network device, where the uplink transmission power configuration information is used to configure an uplink transmission power of the user device;
a processing module, configured to control uplink transmission powers of different antenna panels in the user device according to the uplink transmission power configuration information.

In a seventh aspect, a network device is provided and includes: a transceiver module, configured to send N pieces of uplink transmission power configuration information to a user device, where the uplink transmission power configuration information is used to configure an uplink transmission power of one antenna panel among N antenna panels of the user device.

In an eighth aspect, a network device is provided and includes:
a transceiver module, configured to send uplink transmission power configuration information to a user device, where the uplink transmission power configuration information is used to configure an uplink transmission power of the user device.

In a ninth aspect, a communication device is provided and includes a processor and a memory,
where the memory is configured to store a computer program; and
the processor is configured to execute the computer program to implement a design according to any one of above first aspect or second aspect.

In a tenth aspect, a communication device is provided and includes a processor and a memory,
where the memory is configured to store a computer program; and
the processor is configured to execute the computer program to implement the design according to any one of above third aspect or fourth aspect.

In an eleventh aspect, a computer-readable storage medium is provided, the medium stores instructions that, when called and executed on a computer, cause the computer to perform a design according to any one of above first aspect or second aspect.

In a twelfth aspect, a computer-readable storage medium is provided, the medium stores instructions that, when called and executed on a computer, cause the computer to perform a design according to any one of above third aspect or fourth aspect.

In a thirteenth aspect, a communication system is provided and includes a user device to perform any one of the above and a network device to perform any one of the above.

Other embodiments of the present disclosure will be apparent to those skilled in the art from consideration of the specification and practice of the present disclosure disclosed here. The present disclosure is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the embodiments of the present disclosure being indicated by the following claims.

It should be understood that the embodiments of the present disclosure are not limited to the exact construction that has been described above and illustrated in the accompanying drawings, and that various modifications and changes may be made without departing from the scope thereof. It is intended that the scope of the embodiments of the present disclosure only be limited by the appended claims.

### INDUSTRIAL APPLICABILITY

The user device controls the uplink transmission power for each antenna panel of the user device separately, the configuration and power control are performed with the antenna panel as the granularity. The uplink transmission power corresponding to the transmission capability is allocated to antenna panels with different transmission capabilities, such that the uplink transmission power of each antenna panel matches its transmission capability, which fully utilizes the transmission capability of each antenna panel, thereby avoiding issues of transmission failure caused by insufficient transmission power and adjacent channel interference or energy waste caused by excessive transmission power.

1. A method for receiving uplink transmission power configuration, performed by a user device, comprising:
receiving N pieces of uplink transmission power configuration information sent by a network device, wherein the uplink transmission power configuration information is used to configure an uplink transmission power of one antenna panel among N antenna panels of the user device; and
controlling, according to the N pieces of uplink transmission power configuration information, the uplink transmission powers of the N antenna panels.

2. The method according to claim 1, wherein the uplink transmission power configuration information comprises an identification of the antenna panel;
wherein the controlling the uplink transmission powers of the N antenna panels according to the N pieces of uplink transmission power configuration information comprises:
controlling, according to the identification of the antenna panel, the uplink transmission power of the antenna panel corresponding to the uplink transmission power configuration information.

3. The method according to claim 1, further comprising:
determining, according to a protocol agreement, a maximum uplink transmission power of every antenna panel among the N antenna panels.

4. The method according to claim 1, further comprising:
receiving second uplink transmission power configuration information sent by the network device, wherein the second uplink transmission power configuration information is used to configure an uplink transmission power of the user device; and
controlling, according to the second uplink transmission power configuration information, uplink transmission powers of different antenna panels in the user device.

5. The method according to claim 4, wherein a sum of uplink transmission powers of M antenna panels in the user device is less than or equal to a preset threshold, where M is a positive integer and less than or equal to N, and N is a total number of the antenna panels in the user device.

6. The method according to claim 4, wherein the controlling the uplink transmission powers of the different antenna panels in the user device comprises:
controlling, according to a priority of signals emitted by the different antenna panels, uplink transmission powers of M antenna panels, where M is a positive integer and less than or equal to N, and N is a number of antenna panels comprised in the user device, and a sum of the uplink transmission powers of the M antenna panels in the user device is greater than a preset threshold.

7. The method according to claim 4, wherein the uplink transmission power of the user device is evenly distributed to the uplink transmission power of each antenna panel of the user device.

8. A method for sending uplink transmission power configuration, performed by a network device, comprising:
sending N pieces of uplink transmission power configuration information to a user device, wherein the uplink transmission power configuration information is used to configure an uplink transmission power of one antenna panel among N antenna panels of the user device.

9. The method according to claim 8, wherein the uplink transmission power configuration information comprises an identification of the antenna panel.

10. The method according to claim 8, further comprising:
determining, according to a protocol agreement, a maximum uplink transmission power of every antenna panel among the N antenna panels.

11. The method according to claim 8, further comprising:
sending second uplink transmission power configuration information to the user device, wherein the second uplink transmission power configuration information is used to configure an uplink transmission power of the user device.

12. The method according to claim 11, wherein a sum of uplink transmission powers of M antenna panels in the user device is less than or equal to a preset threshold, where M is a positive integer and less than or equal to N, and N is a total number of the antenna panels in the user device.

13. The method according to claim 11, wherein the uplink transmission power of the user device is evenly distributed to an uplink transmission power of each antenna panel of the user device.

14.-21. (canceled)

22. A communication system comprising a user device and a network device;
wherein the user device comprises a first processor and a first memory;
the first memory is configured to store a first computer program; and
the first processor is configured to execute the first computer program to:
receive N pieces of uplink transmission power configuration information sent by the network device, wherein the uplink transmission power configuration information is used to configure an uplink transmission power of one antenna panel among N antenna panels of the user device; and
control the uplink transmission powers of the N antenna panels according to the N pieces of uplink transmission power configuration information;
wherein the network device comprises a second processor and a second memory;
the second memory is configured to store a second computer program; and
the second processor is configured to execute the second computer program to:
send the N pieces of uplink transmission power configuration information to the user device.

23. The communication system according to claim 22, wherein the uplink transmission power configuration information comprises an identification of the antenna panel; the first processor is configured to:
control the uplink transmission power of the antenna panel corresponding to the uplink transmission power configuration information according to the identification of the antenna panel.

24. The communication system according to claim 22, wherein a maximum uplink transmission power of every antenna panel among the N antenna panels is determined according to a protocol agreement.

25. The communication system according to claim 22, wherein the first processor is further configured to:
receive second uplink transmission power configuration information sent by the network device, wherein the second uplink transmission power configuration information is used to configure an uplink transmission power of the user device; and
control uplink transmission powers of different antenna panels in the user device according to the second uplink transmission power configuration information;
wherein the second processor is further configured to:
send the second uplink transmission power configuration information to the user device.

26. The communication system according to claim 25, wherein a sum of uplink transmission powers of M antenna panels in the user device is less than or equal to a preset threshold, where M is a positive integer and less than or equal to N, and N is a total number of the antenna panels in the user device.

27. The communication system according to claim 25, wherein the first processor is further configured to:
control uplink transmission powers of M antenna panels according to a priority of signals emitted by the different antenna panels, where M is a positive integer and less than or equal to N, and N is a number of antenna panels comprised in the user device, and a sum of the uplink transmission powers of the M antenna panels in the user device is greater than a preset threshold.

28. The communication system according to claim 25, wherein the uplink transmission power of the user device is evenly distributed to the uplink transmission power of each antenna panel of the user device.
